(19) United States
(12) Patent Application Publication
(10) Pub. No.: US 2006/0287762 A1
(43) Pub. Date: Dec. 21, 2006

(54) Method and apparatus for planning the installation position of RFID tags

(76) Inventors: Masatoshi Takada, Hitachi (JP); Kenji Araki, Mito (JP); Kouichi Ushiroda, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/451,328

(22) Filed: Jun. 13, 2006

(30) Foreign Application Priority Data
Jun. 16, 2005 (JP) 2005-176741

(51) Int. Cl. G06F 7/00

(52) U.S. Cl. 700/227; 340/10.1; 700/229; 376/249

(57) ABSTRACT

An RFID installation position planning technology according to the present invention is used for outputting an optimum RFID installation position, which facilitates access to an RFID tag, before construction with work pieces. Work pieces layout data storage device stores work piece layout data including shape and disposition data of a work piece. A working route data storage device stores working route data including position data of works involving communication with the RFID tag. RFID tag position planning means determines communication accessibility to each point on a surface of the work piece from a work position, based on a distance between the work position and the RFID tag, presence or absence of an obstacle there between, and a communicatable distance of the RFID tag. Moreover, the RFID tag position planning means determines and outputs an optimum RFID tag installation position.

### BACKGROUND OF THE INVENTION

1. Field of the Invention

The present invention relates to a technology of planning an installation position of an RFID tag on an object.

2. Description of the Related Art

RFID relates to a technology of attaching an IC chip (RFID tag) with an antenna to an object and contactlessly reading and writing information from and into the IC chip. The RFID enables consistent management of various information related to a life cycle of a workpiece, such as manufacturing, transportation, operation and maintenance.

The RFID is convenient because the RFID enables contactless read and write of information by using radio waves. However, a transmission distance of radio waves is limited, and the radio waves are blocked by obstacles. Thus, some kind of support is required to easily access a target RFID tag. As a technology for facilitating the access to the RFID tag, there is a technology described in Japanese Patent Laid-Open Official Gazette No. 2004-108782 (hereinafter referred to as Patent Document 1). In Patent Document 1, an RFID tag is disposed along a working route and, after an inspection work, guidance is provided based on information in the RFID tag which stores a method for moving to the next inspection position.

In management of a workpiece (which is used, in the present specification, as a broad concept including articles of various sizes such as various parts and so-called devices, and hereinafter the same) which uses an RFID tag, it is important to manage information related to the workpiece in association with the workpiece in order to maintain integrity and consistency of information. Therefore, it is required to install the RFID tag in the workpiece.

For example, pipes in a plant will be taken as an example of the workpiece. The pipes undergo various processes such as manufacturing, transportation, cutting, welding, installation, operation and maintenance. In order to completely manage information in all the processes, it is required to attach the RFID tag from an initial state, for example, from a manufacturing stage. In this event, the tag is attached to a convenient position in a state at the time of manufacturing. However, when the pipe is transported, cut, processed and further installed in the plant after manufacturing, a position and a direction of the pipe are changed. Accordingly, the tag initially attached is not always attached to a position suitable for works such as maintenance. Moreover, the tag is not always attached to apposition which enables reduction in factors that lower performance of the RFID tag, such as noise, moisture and temperature. As described above, the position of the RFID tag to be attached has not heretofore been set to an optimum position from the viewpoint of accessibility to the RFID tag and retention of tag performance by taking account of a layout state and an operation state of the workpiece after construction.

### SUMMARY OF THE INVENTION

It is an object of the present invention to facilitate access to an RFID tag after construction. An RFID installation position planning technology according to the present invention is used for outputting an optimum RFID installation position, which facilitates access to an RFID tag, before construction with work pieces. Work pieces layout data storage device stores workpiece layout data including shape and disposition data of a workpiece. A working route data storage device stores working route data including position data of works involving communication with the RFID tag. RFID tag position planning means determines communication accessibility to each point on a surface of the workpiece from a work position, based on a distance between the work position and the RFID tag, presence or absence of an obstacle therebetween, and a communicatable distance of the RFID tag. Moreover, the RFID tag position planning means determines and outputs an optimum RFID tag installation position.

Specifically, according to an aspect of the present invention, provided is an RFID position planning apparatus characterized by including: a workpiece layout data storage device which stores workpiece layout data including shape and disposition data of a workpiece; a working route data storage device which stores working route data including work position data involving communications with an RFID tag; and RFID tag position planning means which determines that a position being in a communicatable range from a position specified by the work position data, and having a maximum signal intensity in communications, should be an installation range or an installation position of the RFID tag in the workpiece, based on the workpiece layout data and the working route data. Thus, the installation range or the installation position of the RFID tag in the workpiece can be determined with high accuracy.

The workpiece layout data storage device is characterized by storing noise data indicating positions of noise sources which affect communication performance of the RFID tag. Moreover, the RFID tag position planning means is characterized by determining that a position being outside a range of influences of the noise sources, being in a communicatable range from a position specified by the working position data, and having a maximum signal intensity in communication, should be an installation range or an installation position of the RFID tag in the workpiece, based on the workpiece layout data, the working route data and the noise data. Thus, the installation range or the installation position of the RFID tag in the workpiece can be determined with high accuracy while taking account of the influences of noise.

Moreover, the apparatus is characterized by further including an operation data storage device which stores operation data including operation conditions of the workpiece. The RFID tag position planning means is characterized by determining presence or absence of a covering material on the workpiece and determining an attachment/detachment range of the covering material, based on the operation data, the workpiece layout data and the working route data. Moreover, the RFID tag position planning means is characterized by determining an installation range or position of the RFID tag in the workpiece by limiting the range or position to the determined attachment/detachment range. Thus, it is possible to reduce a work for attachment/detachment of covering material for communications with the RFID tag.

As described above, according to the present invention, the installation position for facilitating the access to the RFID tag installed in the workpiece can be determined before construction based on a workpiece layout condition. Thus, there is an advantage that the RFID tag installation position can be easily optimized.

### BRIEF DESCRIPTION OF THE DRAWINGS

FIG. 1 is a block diagram showing an example of a system configuration of an apparatus for planning an installation position of an RFID tag according to a first embodiment of the present invention.

FIG. 2 is a table showing an example of a data storage format in a workpiece layout data storage device according to this embodiment.

FIG. 3 is a view showing examples of workpiece data stored in the workpiece layout data storage device according to this embodiment.

FIG. 4 is a table showing an example of a data storage format in a working route data storage device according to this embodiment.

FIG. 5 is a table showing an example of a data storage format in the working route data storage device according to this embodiment.

FIG. 6 is a view showing an example of a working route according to this embodiment.

FIG. 7 is a flowchart showing a flow of processing by RFID position planning means according to this embodiment.

FIG. 8 is a view showing a state where a surface of a part shape or a shape element specified by each ID in workpiece layout data according to this embodiment is split into triangular polygon elements.

FIG. 9 is a table showing an example of workpiece coordinates data acquired by the RFID position planning means according to this embodiment.

FIG. 10 is a view showing an example of an output screen of the RFID position planning means according to this embodiment.

FIG. 11 is a table showing an example of a noise data storage format in a workpiece layout data storage device according to a second embodiment of the present invention.

FIG. 12 is a flowchart showing a flow of processing by RFID position planning means according to this embodiment.

FIG. 13 is a block diagram showing an example of a system configuration of RFID position planning means according to a third embodiment of the present invention.

FIG. 14 is a table showing an example of a data storage format in an operation data storage device according to this embodiment.

FIG. 15 is a flowchart showing a flow of processing by the RFID position planning means according to this embodiment.

### DETAILED DESCRIPTION OF THE PREFERRED EMBODIMENTS

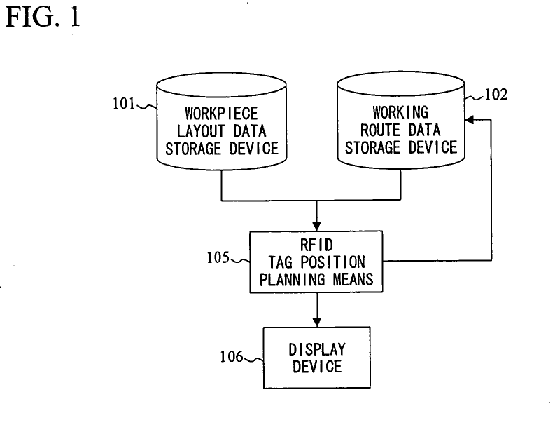

With reference to the drawings, description will be given below of an example of an RFID installation position planning apparatus according to a first embodiment of the present invention. FIG. 1 shows a configuration example of the RFID installation position planning apparatus according to this embodiment. As shown in FIG. 1, the RFID installation position planning apparatus according to this embodiment includes: a workpiece layout data storage device 101; a working route data storage device 102; RFID tag position planning means 105 for determining an optimum tag installation position, based on workpiece layout data, operation route data, working data and tag data; and a display device 106. Hereinafter, detailed descriptions will be given of the above.

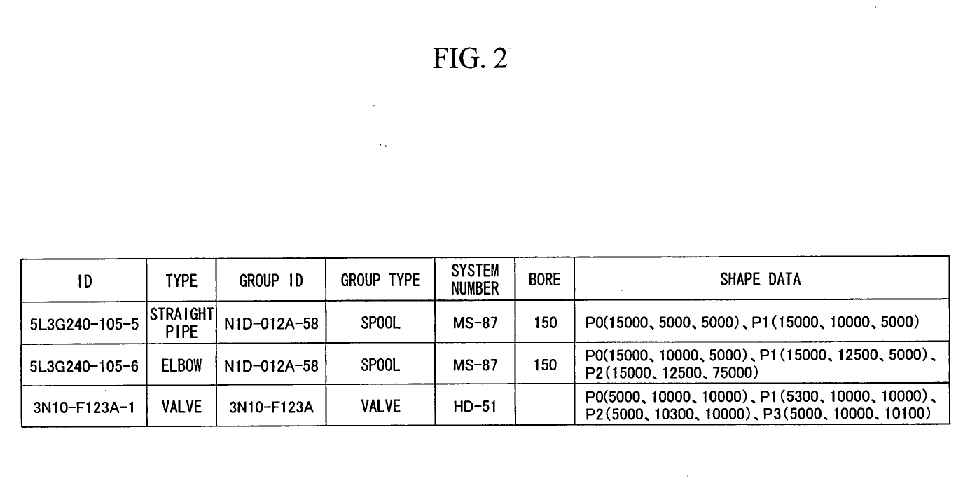

The workpiece layout data storage device 101 stores workpiece layout data that is information concerning shapes and layout of workpieces, such as piping and equipment, which are installed, for example, in a facility such as a plant. FIG. 2 shows an example of a data structure of the workpiece layout data. As shown in FIG. 2, the workpiece layout data are stored for each part of a workpiece or for each constituent element of a part shape. In an ID column, IDs for identifying for each constituent element are stored. In a type column, a part type or a shape type, such as a straight pipe, an elbow and a valve, is stored, which is identified by the ID. In a group ID column, identification IDs concerning units for attaching workpieces are stored. This attachment unit is an assembly unit in the case where a device formed by combining shape elements, or a workpiece by the ID unit, is not directly constructed at a construction site, but some parts are assembled beforehand and the assemblies are put together at the site. For example, the straight pipe and the elbow have the same group ID, and are set in one group as a spool previously processed. This means that the workpiece is in a state where the straight pipes are combined by use of the elbow. In a group type column, a device type is stored when the attachment unit is a device, and an assembly type is stored in the case of a preassembly unit. If the workpiece is neither a device nor a preassembled article, the group ID column and the group type column are left blank. In a system number column, numbers of systems to which workpieces belong are stored. The system number is the number provided based on a starting material. In a bore column, a bore value of a workpiece or a shape is stored. In a shape data column, stored are coordinate values as three-dimensional arrangement data for shape definition.

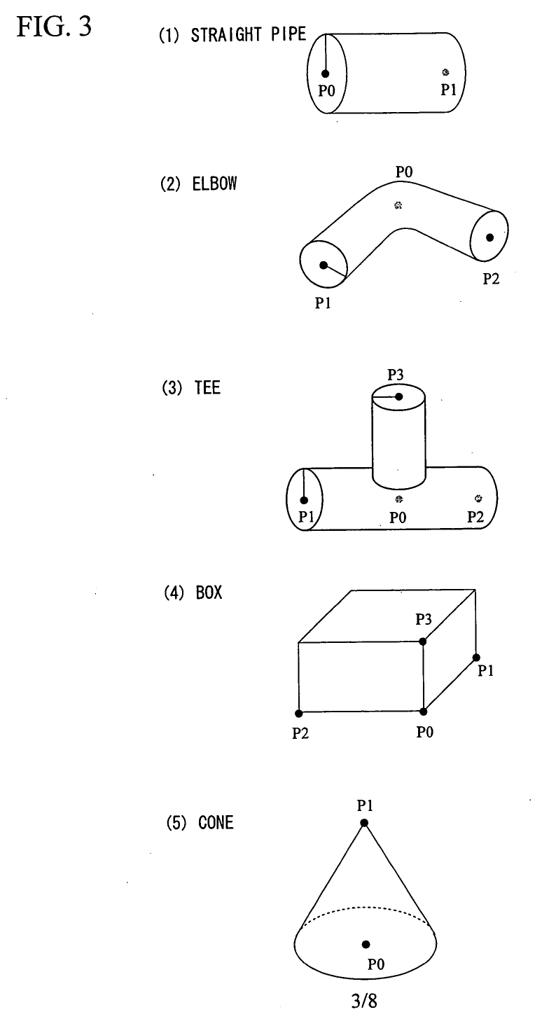

As a data format stored in the shape data column, for example, as shown in FIG. 3 (1) to (5), point coordinate values previously defined for each type are used, such as center points P0 and P1 at both ends in the case of a straight pipe (1), and P1, P0 and P2 at the center in the case of an elbow (2). The workpiece layout data can be prepared by utilizing, for example, three-dimensional CAD and the like. In the case of the straight pipe or the elbow, a position and a size of a workpiece are set based on the values described above and the bores shown in FIG. 2.

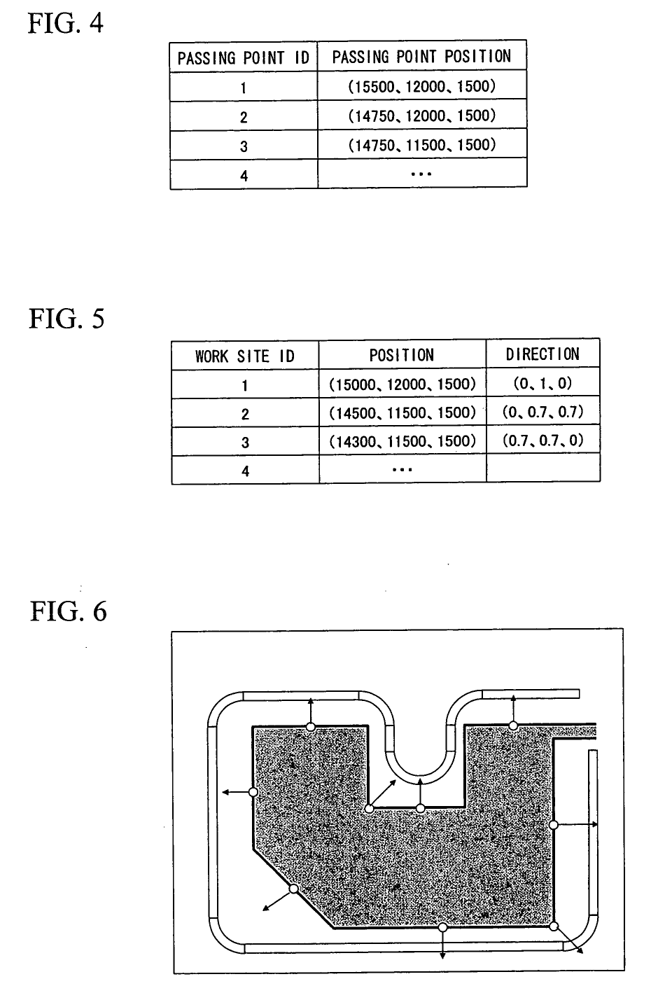

The working route data storage device 102 stores: route data indicating a route by which a working moves; and working site data indicating a position where the operator performs works along the route data. FIG. 4 shows a data storage format of working route data. As shown in FIG. 4, position coordinates of a passing point on the route are stored in a passing point position column, and an ID number for specifying the passing point is stored in a passing point ID column. The working route data are prepared based on the workpiece layout data shown in FIG. 2 and further by taking account of workability and safety of the working and a distance within which an RFID tag and a reader or a reader/writer can communicate with each other.

FIG. 5 shows a storage format of the working site data. As shown in FIG. 5, an ID number for specifying a work site is stored in a work site ID column, and a position of a worker at the site and a direction in which the worker performs works are stored in a position column and a direction column, respectively. The work site data is prepared by a user (a plant builder/designer or a plant operation/maintenance planner) based on the route data. Alternatively, as an initial value, a direction toward an adjacent workpiece is prepared at fixed intervals on the route data, or a point on the route data, which is the closest to one point (a shape data point in the workpiece layout data) of a workpiece in which an. RFID tag is to be installed, can be taken.

FIG. 6 shows an example of a defined maintenance route. A maintenance route R2 that is a route along which maintenance is performed is provided along a piping route R1. Respective positions facing respective workpieces provided on the piping route R1 from the maintenance route R2 are positions, which are indicated by circles, for accessing RFID tags. As indicated by the arrows, it is possible to access the RFID tags provided in the respective workpieces from the access positions indicated by the circles. Note that, if neither the route data nor the work site data are set, it is also possible to prepare work site data by setting a position with a certain height from a floor or a scaffold, which is away from the workpiece having the RFID tag installed by a communicatable distance, as a work site, and to set a route which connects the work sites and does not interfere with the workpieces as route data.

The RFID tag position planning means 105 shown in FIG. 1 determines an optimum installation position of an RFID tag in a workpiece, based on the workpiece layout data shown in FIG. 2 and the working route data shown in FIG. 4.

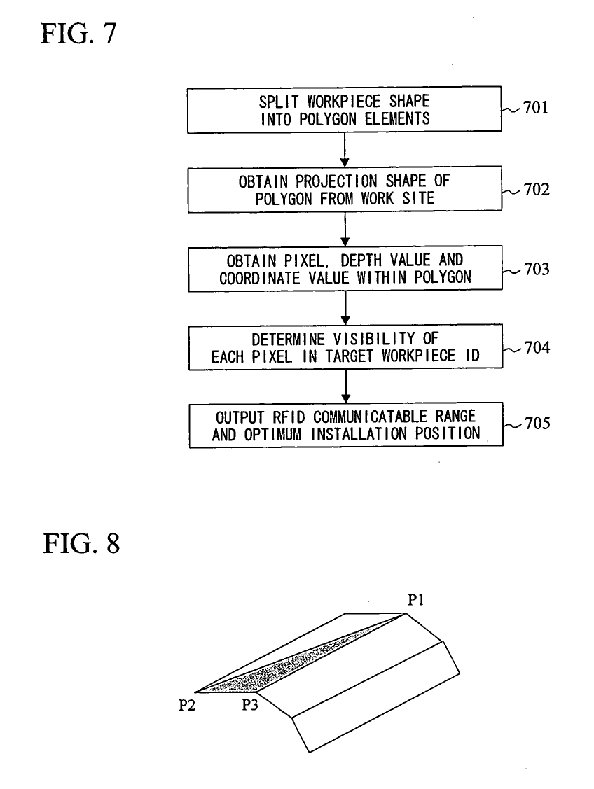

FIG. 7 is a flow chart showing a flow of planning processing by the RFID tag position planning means 105 (FIG. 1) for * determining the installation-position of the RFID tag in the workpiece. As to a workpiece ID, first, a workpiece in which an RFID tag is to be installed, the workpiece being specified by a user, is set as an initial target. In Step 701, a surface of a part shape or a shape element, which is specified by each ID in workpiece layout data, is split into triangular polygon elements. In this event, for example, in the case of a curved surface such as a columnar shape, the surface is split into an approximate shape such as respective faces of a polygonal column. FIG. 8 shows a split example. As shown in FIG. 8, vertices of a polygon in a colored triangular region are set to P1, P2 and P3. The polygon can be specified by P1, P2 and P3.

Next, a projection shape of the polygon is obtained by setting respective positions and directions in work site data as a projection direction (Step 702). The projection shape is obtained by projection conversion by setting a workpiece coordinate system as a world coordinate system and by setting a position and a direction of a work site as a position and a direction of a camera coordinate system. It is assumed that the world coordinate system is V(X, Y, Z), the camera coordinate system is v(x, y, z), projection plane coordinates are s(u, v), a rotation matrix from the world coordinate system to the camera coordinate system is R, a translation matrix is T, and a projection focal distance is f. R and T can be obtained from the direction and the position in the work site data. Moreover, f and a projection plane width W (u and v range) can be obtained by the following equation from a read angle range θ of a reader of the RFID tag.
θ=2*tan⁻¹(w/2f) [Equation 1]

Here, a projection formula from the camera coordinate system v to the projection plane coordinates s is expressed as follows.

[Equation 2]

$$u = \frac{{P}_{11} X + {P}_{12} Y + {P}_{13} Z + {P}_{14}}{{P}_{31} X + {P}_{32} Y + {P}_{33} Z + {P}_{34}} \\ v = \frac{{P}_{21} X + {P}_{22} Y + {P}_{23} Z + {P}_{24}}{{P}_{31} X + {P}_{32} Y + {P}_{33} Z + {P}_{34}} \qquad [ Equation 2 ]$$

,where Pij is a ij component of the following matrix.

[Equation 3]

$$\begin{matrix}P = A ⌊ {R}^{T} \vert - {R}^{T} T ⌋ & A = [ \begin{matrix}f & 0 & 0 \\ 0 & f & 0 \\ 0 & 0 & 1\end{matrix} ]\end{matrix} \qquad [ Equation 3 ]$$

Next, in a screen coordinate system, a screen pixel included in a projected polygon shape, a depth value z thereof, and a world coordinate value are obtained (Step 703). The pixel is determined by obtaining an intersection point between a scan line y=y1 and a projected triangle of the polygon and by obtaining a screen pixel existing within the intersection points.

In order to obtain the value z, a formula of a plane including P1, P2 and P3 is obtained and the following equation is established.
ax+by+cz+d=0
Thus, the depth value z at the screen coordinates (u, v) can be obtained by the following equation.
z=−(ax+by+d)/c
Furthermore, camera coordinates are obtained by the following equations.
x=u*z/f, y=v*z/f, z=depth value
Moreover, world coordinates are obtained by the following equation.
V=Rv+T

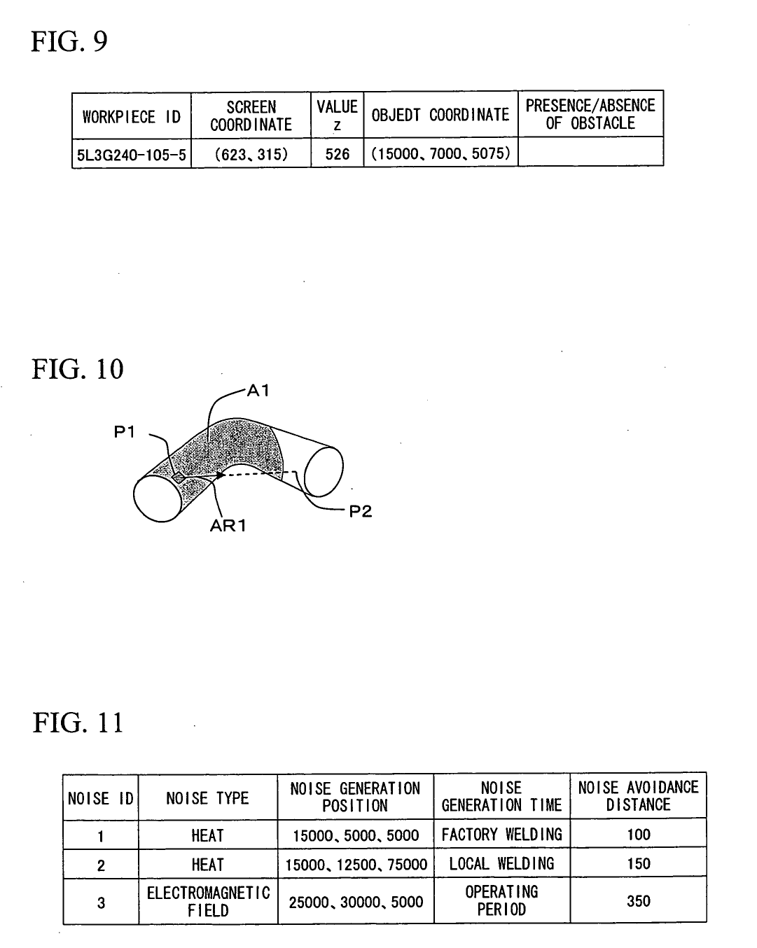

The above-described processing in Step 703 is performed for all the screen pixels or pixels at certain intervals within the polygon shape. The results obtained are stored in workpiece coordinate data shown in FIG.9. In a workpiece ID column, a screen coordinate column (u, v), a z value column, and an object coordinate column (x, y, z), an ID or a group ID of the target workpiece and the values obtained are entered, respectively.

Next, visibility of each pixel in the target workpiece ID is determined (Step 704). In this Step 704, Steps 701 to 703 are carried out for all workpiece shapes or for workpiece shapes in a region limited to only a display range after the workpiece in which the RFID tag is to be installed, the workpiece being specified by the user. Thereafter, data having the same screen coordinates are searched through the workpiece coordinate data. If there are the data as a result of the search and if the value z is smaller than the stored value, it is determined that there is an obstacle. Accordingly, in an obstacle presence/absence column shown in FIG. 9, “present” is entered.

Next, in Step 705, an RFID tag installation range and an optimum installation position are outputted. Note that, by the processing of Steps 701 to 704, a position (range) that is visible from a work site on an object is obtained. In addition, radio waves for RFID communications are considered to be transmitted while going approximately straight. Thus, a visible range from the work site, which is obtained by the processing of Steps 701 to 704, can be regarded as approximately the same as a communicatable range of the RFID tag. Therefore, it is possible to know a communicatable position in the target workpiece.

Note that, in the case where transmission of the radio waves is not almost completely straight but it is required to also consider transmission toward a periphery by diffraction, reflection or the like, coordinates of an object around the visible range are also determined to be the communicatable range. Thus, the communicatable position can be specified.

Moreover, as to the optimum installation position of the RFID tag, a position (point) that is the closest to the work site among the communicatable positions is determined to be the optimum installation position of the RFID tag. Thereafter, the communicatable position and the optimum installation position of the RFID tag, which are determined, are outputted. Moreover, in this event, a direction of installation of the RFID tag can also be indicated by adding an arrow AR1 indicating a direction of the work site to the optimum installation position. FIG. 10 shows a display (output) example on the display device 106 (FIG. 1). A region A1 that is shaded in FIG. 10 is a region in which no information can be read from the RFID tag due to an obstacle. In the case where a position P1 obtained as the installation position of the RFID tag by the processing described above is within the region A1, a point P2 outside the region A1 is obtained, which is a position P2 of the workpiece on the line extended from the position P1 in the direction of the arrow AR1. Accordingly, it is preferable that P2 is set as the installation position of the RFID tag. As described above, by allowing the display device to display a position suitable as the installation position of the RFID tag, there is an advantage that it is easy for the user to recognize the installation position of the RFID tag.

Note that it is difficult to strictly specify one point among the work sites (positions indicated by the circles in FIG. 6) where communications with the RFID tags are performed on the maintenance route shown in FIG. 6. It is preferable that the RFID tags are installed in communicatable positions from the work sites within a broader range. Thus, a plurality of points close to the work sites are prepared along the work route, and the processing of Steps 701 to 705 is performed for those points. Thereafter, a range within which communications can be performed at all or most of the points is set as a communicatable range. Moreover, a point most frequently determined to be an optimum position or a center point among the plurality of points determined to be the optimum positions can also be determined to be an optimum installation point and outputted. It is actually rather more practical to perform this processing.

As described above, by allowing a researcher carrying an RFID reader or the like to move along the maintenance route, it is possible to acquire various information concerning life cycles of the workpieces, which are stored in the RFID tags installed in the workpieces. Thus, it is possible to compare the data obtained with the previous research data or to pay attention to data having a large difference from a standard value or a predicted value and to data having a small difference from a use limit value.

As described above, by use of the RFID tag installation position planning technology according to this embodiment, based on the workpiece layout and the work (maintenance), the installation position of the RFID tag can be determined by taking account of accessibility to the RFID tag installed in the workpiece along the maintenance route. Thus, there is an advantage that maintenance work is facilitated. Furthermore, the installation position is determined by taking account of communication properties of the RFID tag, particularly, linearity of radio waves and presence or absence of an obstacle. Thus, there is an advantage that maintenance work more suitable for an actual facility can be performed.

Next, with reference to the drawings, description will be given of an RFID installation position planning technology according to a second embodiment of the present invention. In the RFID installation position planning technology according to this embodiment, the workpiece layout data storage device 101 shown in FIG. 1 stores noise-related data indicating noise sources that may affect communications and performance of RFID tags and types of the noise sources. Moreover, indetermination processing executed by RFID position planning means, positions of the RFID tags can be determined by utilizing the data described above.

FIG. 11 shows an example of a storage format of noise data. As shown in FIG. 11, identification IDs are stored in a noise ID column, types of noise generated are stored in a noise type column, noise generation positions are stored in a noise generation position column, and minimum distances between the noise sources and the positions of the RFID tags for avoiding the noise are stored in an avoidance distance column. As the noise, there is an electromagnetic field noise generated from a power source or an inverter, for example. In this case, an electromagnetic field is stored in the noise type column, generation center coordinates are stored in the noise generation position column, and process in which noise is generated are stored in a noise generation time column. Moreover, in the avoidance distance column, stored is a minimum distance obtained from electromagnetic field intensity of the noise source, a range attenuation rate and noise intensity affecting the RFID tag. In the noise type column, heat can be set in order to also consider influence of heat in welding on the RFID tag. In this case, it is possible to store a center of a welded spot as the noise generation position, and shop welding and on-site welding as the noise generation time. Moreover, as the noise avoidance distance, a minimum distance for avoiding noise can be stored, which is obtained by taking account of a heat-resistant temperature, welding and an annealing temperature of the RFID tag, and heat transfer and radiation rate of the workpiece.

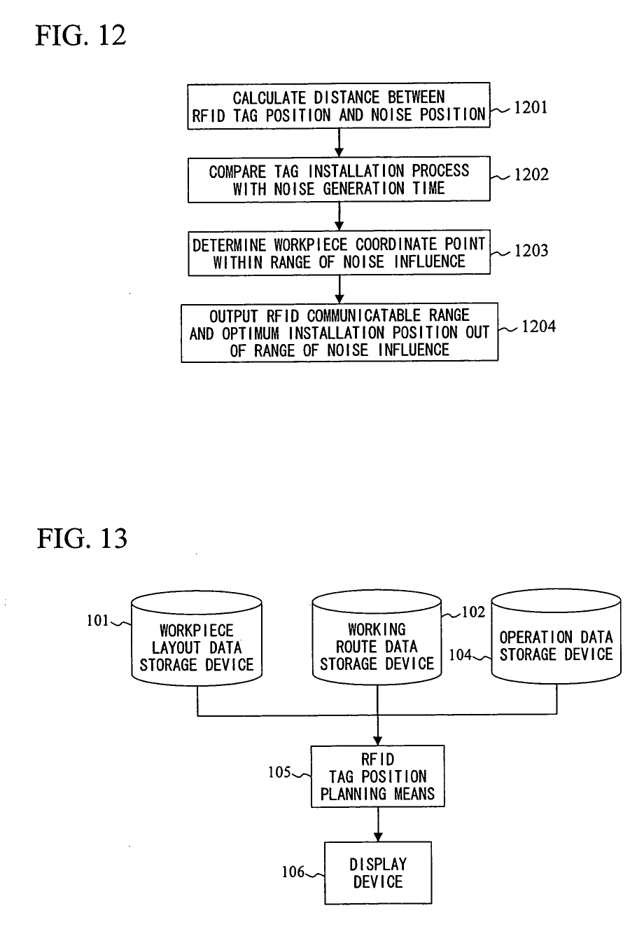

FIG. 12 is a flowchart showing a flow of processing added to the processing shown in FIG. 7, which is executed by the RFID position planning means in the case where noise is taken into consideration. As shown in FIG. 12, in Step 1201, subsequent to Step 705 in FIG. 7, a distance between the RFID position obtained and each noise position in the noise data is obtained. Thereafter, if the distance between the RFID position and each noise position is not less than the noise avoidance distance, the processing is finished. On the other hand, if the distance between the RFID position and each noise position is not more than the noise avoidance distance, the processing moves to Step 1202. In Step 1202, a tag installation step inputted by the user is compared with the noise generation time, and, if the tag installation step is after the noise generation time, the processing is finished. For example, an RFID tag installed after welding processing is not affected by heat generated in welding. If the tag installation step is before the noise generation time, the processing moves to Step 1203 since the tag is affected by the heat generated in welding.

In Step 1203, a distance between the noise generation position and each point in the workpiece coordinate data is obtained. If the distance obtained is not more than the noise avoidance distance, noise ID data are additionally stored in the obstacle presence/absence column. In Step 1203, in addition to the processing in Step 704 shown in FIG. 7, if a noise ID is stored in the obstacle presence column, it is determined that the corresponding point is not suitable as an RFID installation position due to the noise influence. In Step 1204, in addition to the processing in Step 705 shown in FIG. 7, a range, including points whose noise IDs are not stored in the obstacle presence/absence column from the workpiece coordinate data, is set as an RFID tag installation range. Moreover, a point closest to a work site within the RFID tag installation range is determined to be the RFID installation position.

As described above, in the RFID installation position planning technology according to this embodiment, the RFID installation position is determined by taking account of the influence of the sources of noise. Thus, in a plant having sources of noise, there is an advantage that the RFID installation position can be determined with higher accuracy.

Next, with reference to the drawings, description will be given of an RFID installation position planning technology according to a third embodiment of the present invention. In this embodiment, adopted is a configuration obtained by adding an operation data storage device to the configuration in each of the embodiments described above. RFID position planning means can determine a position of an RFID tag by additionally utilizing operation conditions.

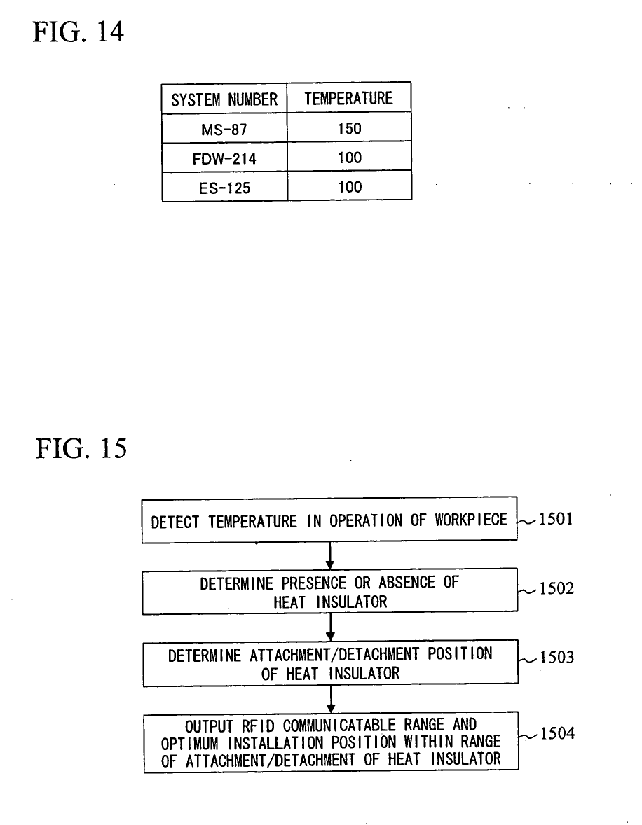

FIG. 13 shows a configuration example of an RFID position planning apparatus according to this embodiment. As shown in FIG. 13, the RFID position planning apparatus according to this embodiment includes an operation data storage device 104 in addition to the configuration shown in FIG. 1. The operation data storage device 104 stores operation condition data on workpieces. For example, a heat insulator wound around a pipe and the like correspond thereto. In the case of attaching an RFID tag, the tag cannot be attached onto such a heat insulator on the pipe. Thus, it is required to peel off the heat insulator from the pipe. Consequently, a position where the heat insulator is easily peeled off is suitable as an attachment position. FIG. 14 shows an example of a storage format of operation data. As shown in FIG. 14, numbers of systems are stored in a system number column, and operation temperatures of the systems are stored in a temperature column. The heat insulator is intended to realize heat insulation of a high-temperature pipe, prevention of dew condensation on a low-temperature pipe or the like, and is specified by a temperature to be maintained.

FIG. 15 is a flowchart showing additional processing by the RFID position planning means according to this embodiment. As shown in FIG. 15, in Step 1501, an operation temperature of a fluid flowing through a workpiece, for example, a pipe is retrieved by using a system number, to which the workpiece belongs in the operation data storage device, as a search key. In Step 1502, performed is determination of whether to install a heat insulator on the workpiece. As the heat insulator, a covering material for heat insulation, cold insulation and dew condensation prevention is included. As to the determination of whether to install the heat insulator, if the operation temperature of the workpiece is not lower than 60° C. or not higher than 0C or if the operation temperature is not higher than a dew-point temperature at an installation site of the workpiece, installation of the heat insulator is determined to be necessary. Next, in Step 1503, a heat insulator attachment/detachment position is determined.

As a heat insulator attachment/detachment portion, a welded part subjected to in-service inspection corresponds thereto. Thus, if a welded part spot is stored in the noise generation data among the target workpieces, the corresponding position is set as the heat insulator attachment/detachment portion. On the other hand, if the welded part spot is not stored therein, portions at both ends of the workpiece are set as the heat insulator attachment/detachment position. Furthermore, a position within 100 mm from the end position of the workpiece, which is the welded part, is set as the attachment/detachment position. Setting of a value of an attachment/detachment range can be specified by the user. Thereafter, a character string “heat insulator present” is additionally stored in each point of the workpiece coordinate data other than the determined heat insulator attachment/detachment position.

Next, in Step 1504, an RFID tag installation position is determined. In addition to the processing in Step 705 shown in FIG. 7, a range, including points where the character string “heat insulator present” is not stored in the obstacle presence column from the workpiece coordinate data, is set as an RFID tag installation range. Moreover, a point closest to an operation site within the RFID tag installation range is determined to be the RFID tag installation position.

By the processing as described above, a heat insulator attachment/detachment portion is determined. In this heat insulator detachable portion, the heat insulator is attached or detached more easily than in the heat insulator portions other than the heat insulator attachment/detachment portion. Thus, a work for attaching/detaching the heat insulator for installing the RFID tag is simplified. Consequently, there is an advantage that a work for communicating with the RFID tag is simplified. As described above, according to the respective embodiments of the present invention, the RFID tag installation position for facilitating the access to the RFID tag installed in the workpiece can be determined before construction based on a workpiece layout condition. Thus, there is an advantage that the RFID tag installation position can be easily optimized.

Besides maintenance and inspection of the plant, the present invention is also applicable to maintenance and inspection of other buildings and structures.

What is claimed is:

1. An RFID position planning apparatus comprising:
a workpiece layout data storage device which stores workpiece layout data including shape and disposition data of a workpiece;
a working route data storage device which stores working route data including working position data involving communication with an RFID tag; and
RFID tag position planning means which determines that a position being in a communicatable range from a position specified by the working position data, and having a maximum signal intensity in communication, should be an installation range or an installation position of the RFID tag in the workpiece, based on the workpiece layout data and the working route data.

2. The RFID position planning apparatus according to claim 1, wherein
the workpiece layout data storage device stores noise data indicating positions of noise sources which affect communication performance of the RFID tag, and
the RFID tag position planning means determines that a position being outside a range of influences of the noise sources, being in a communicatable range from a position specified by the working position data, and having a maximum signal intensity in communication, should be an installation range or an installation position of the RFID tag in the workpiece, based on the workpiece layout data, the working route data and the noise data.

3. The RFID position planning apparatus according to claim 1, further comprising:
an operation data storage device which stores operation data including operation conditions of the workpiece,
wherein the RFID tag position planning means determines presence or absence of a covering material on the workpiece and an attachment/detachment range of the covering material, based on the operation data, the workpiece layout data and the working route data, and determines an installation range or position of the RFID tag in the workpiece by limiting the range or position to the determined attachment/detachment range.

4. An RFID position planning method for determining a position to install an RFID tag in a workpiece, comprising the steps of:
inputting working layout data related to layout of the workpiece;
inputting operation route data on a route for performing works related to the workpiece; and
determining that a position being in a communicatable range from a work position, and having a maximum signal intensity in communications, should be an installation range or position of the RFID tag in the workpiece, based on the workpiece layout data and the working route data.

5. The RFID position planning method according to claim 4, further comprising the steps of:
inputting noise data specifying noise sources related to communication of the RFID tag; and
determining that a position being outside a range of influences of noise should be an installation range or position of the RFID tag in the workpiece, based on the noise data.

6. The RFID position planning method according to claim 4, further comprising the steps of:
inputting operation data;
determining presence or absence of a covering material on the workpiece and an attachment/detachment range of the covering material, based on the operation data, the workpiece layout data and the working route data; and
determining an installation range or position of the RFID tag in the workpiece by limiting the range of position to the determined attachment/detachment range.
